(19) United States
(12) Patent Application Publication
(10) Pub. No.: US 2016/0147331 A1
(43) Pub. Date: May 26, 2016

(54) TOUCH PANEL, DISPLAY APPARATUS AND ELECTRONIC DEVICE

(71) Applicant: Sony Corporation, Tokyo (JP)

(72) Inventors: Yingying QIN, Beijing (CN); Yi WANG, Beijing (CN)

(21) Appl. No.: 14/427,039

(22) PCT Filed: Oct. 2, 2014
(86) PCT No.: PCT/IB2014/065011

§ 371 Date: Mar. 10, 2015

(30) Foreign Application Priority Data
Mar. 10, 2014 (CN) 201410085654.9

(51) Int. Cl. G06F 3/044; G06F 3/041

(52) U.S. Cl. CPC G06F 3/044; G06F 3/0412; G06F 2203/04103

(57) ABSTRACT

The present disclosure provides a touch panel, a display apparatus and an electronic device. The touch panel includes: a substrate having a rectangular detection region and electrode regions located at the peripheries of the detection region; a plurality of detection lines formed in the detection region and electrically separated from one another; a plurality of driving lines formed in the detection region and electrically separated from one another; a plurality of electrodes located in the electrode regions and electrically connected to the detection lines and the driving lines, respectively; wherein, the detection lines and the driving lines are configured crosswise, and the extending directions of the detection lines and/or the driving lines are not parallel with any side of the detection region. According to embodiments of the present disclosure, the area of the electrode regions in the touch panel can be reduced, thereby forming a touch panel of compact structure.

### CROSS REFERENCE TO RELATED APPLICATIONS

This application claims priority from Chinese patent application No. 201410085654.9, filed Mar. 10, 2014, the entire disclosure of which hereby is incorporated by reference.

### TECHNICAL FIELD

The present disclosure relates to the field of touch technologies, and particularly, to a touch panel, a display apparatus and an electronic device.

### BACKGROUND ART

In recent years, display apparatuses with touch panels are widely used. According to the operation principle, the touch panels may be classified into a resistance film type, a capacitive coupling type, an infrared type, an electro-magnetic induction coupling type, and an ultrasonic type, etc.

The touch panel of the capacitive coupling type has the advantage of high speed detection of the touch position. In the touch panel of the capacitive coupling type, detection lines and driving lines configured into a vertical and horizontal 2D matrix are provided in a detection region corresponding to a display region of a display apparatus, and capacitors are formed at the intersections of the detection lines and the driving lines. When the touch panel is touched, the capacitance at a touch point is changed. Thus the coordinates of the touch position can be calculated by detecting a change signal of each capacitor.

FIG. 1 is a schematic diagram of the structure of a touch panel in the relevant art. In FIG. 1, a substrate 2 of a touch panel 1 has a detection region 4, in which a plurality of detection patterns 5 configured into an X-Y matrix are formed. Electrode regions 6 are formed at the peripheries of the upper side, the lower side and the right side of the detection region 4. Wiring electrodes 7 are provided in the electrode regions 6. In the detection region 4, a column of detection line patterns 5a formed in direction X are electrically connected to each other, and connected to the wiring electrode 7 at the right side, while a column of driving line patterns 5b formed in direction Y are electrically connected to each other, and connected to the wiring electrode 7 at the upper side or lower side. As shown in FIG. 1, the wiring electrodes 7 are converged at the right end of the substrate to form a terminal portion TA, which may be connected to a flexible substrate, so as to connect the wiring electrodes 7 to an external circuit.

FIG. 2 is another schematic diagram of the structure of a touch panel in the relevant art. As shown in FIG. 2, the diamond detection patterns of a touch panel 8 are different from the rectangular detection patterns in FIG. 1. Except this, the structure of the touch panel 8 in FIG. 2 is similar to that of the touch panel 1 in FIG. 1, i.e., the detection region has a plurality of detection patterns configured into an X-Y matrix, wherein a column of detection line patterns formed in direction X are electrically connected to each other, and connected to the wiring electrode at the right of the touch panel, while a column of driving line patterns formed in direction Y are electrically connected to each other, and connected to the wiring electrode above or below the touch panel. In addition, electrode regions 9 are formed at the peripheries of the upper side, the lower side and the right side of the detection region, and the wiring electrodes are provided in the electrode regions 9.

To be noted, the above introduction to the technical background is just made for the convenience of clearly and completely describing the technical solutions of the present disclosure, and to facilitate the understanding of a person skilled in the art. It shall not be deemed that the above technical solutions are known to a person skilled in the art just because they have been illustrated in the Background section of the present disclosure.

### SUMMARY

In the existing prior touch panels, since the detection patterns extend along directions X and Y, electrode regions are provided outside at least three sides of the substrate, which increases the size of the periphery of the detection region, and then increases the border sizes of the touch panel in directions X and Y. In addition, with the continuous increase of the size of the touch panel, the number of the detection patterns increasingly rises, and the number of wiring electrodes connected to the detection patterns also largely increases; thus, the electrode regions shall occupy more areas to accommodate the wiring electrodes, thereby further expanding the border size of the touch panel, which is adverse to form a touch panel of compact structure.

The embodiments of the present disclosure provide a touch panel, a display apparatus and an electronic device, which can reduce the area of the electrode regions in the touch panel, thereby forming a touch panel of compact structure.

According to a first aspect of the embodiments of the present disclosure, a touch panel is provided, including: a substrate having a rectangular detection region and electrode regions located at the peripheries of the detection region; a plurality of detection lines formed in the detection region and electrically separated from one another; a plurality of driving lines formed in the detection region and electrically separated from one another; a plurality of electrodes located in the electrode regions and electrically connected to the detection lines and the driving lines, respectively; wherein, the detection lines and the driving lines are configured crosswise, and the extending directions of the detection lines and/or the driving lines are not parallel with any side of the detection region.

According to a second aspect of the embodiments of the present disclosure, the electrode regions are located outside two opposite sides of the detection region.

According to a third aspect of the embodiments of the present disclosure, the detection line and the driving line are perpendicular or not perpendicular to each other.

According to a fourth aspect of the embodiments of the present disclosure, the detection lines are parallel with one another, the driving lines are parallel with one another, and a distance between any adjacent two of the detection lines is equal to a distance between any adjacent two of the driving lines.

According to a fifth aspect of the embodiments of the present disclosure, an angle between one side of the detection region and the detection line and an angle between the side and the driving line are supplementary to each other.

According to a sixth aspect of the embodiments of the present disclosure, electrodes connected to the detection lines and electrodes connected to the driving lines are arranged alternatively.

According to a seventh aspect of the embodiments of the present disclosure, the detection lines and the driving lines are made of transparent conductive material.

According to an eighth aspect of the embodiments of the present disclosure, the detection lines and the driving lines are electrically insulated from each other at an intersection.

According to a ninth aspect of the embodiments of the present disclosure, the detection lines and the driving lines are located on upper and lower surfaces of the substrate, respectively.

According to a tenth aspect of the embodiments of the present disclosure, the detection lines and the driving lines are located on the same surface of the substrate.

According to an eleventh aspect of the embodiments of the present disclosure, the substrate has two layers, and the detection lines and the driving line are provided on different layers of the substrate, respectively.

According to a twelfth aspect of the embodiments of the present disclosure, the touch panel has more than two detection regions which are located on different planes.

According to a thirteenth aspect of the embodiments of the present disclosure, a display apparatus is provided, including a touch panel according to any of the first to twelfth aspects and an electrical connection device, wherein the detection lines and the driving lines of the touch panel are electrically connected to the electrical connection device through the electrodes.

According to a fourteenth aspect of the embodiments of the present disclosure, the electrical connection device is a flexible printed circuit board.

According to a fifteenth aspect of the embodiments of the present disclosure, an electronic device is provided, including a display apparatus according to the thirteenth aspect or the fourteenth aspect.

The present disclosure has the following beneficial effect: by setting the detection lines and/or the driving lines to be not parallel with any side of the detection region, the number of electrodes above and below the detection region is increased, while the number of electrodes on the left and right of the detection region is decreased. The areas of the electrode regions outside the left and right sides of the detection region are reduced, and a touch panel of compact structure is formed.

With reference to the subsequent text and drawings, embodiments of the present disclosure are disclosed in detail to indicate the ways of employing principles of the disclosure. It shall be appreciated that the scope of embodiments of the present disclosure is not limited thereto. The embodiments of the present disclosure include many changes, modifications and equivalents within the scope, spirit and clauses of the accompanying claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

### BRIEF DESCRIPTION OF DRAWINGS

The included drawings provide further understanding of the present disclosure, and they constitute a part of the Specification. The drawings illustrate the preferred embodiments of the present disclosure, and explain principle of the present disclosure together with the text. The following drawings illustrate some embodiments of the present disclosure, and a person skilled in the art can obtain other drawings from those drawings without paying any creative effort.

In the drawings:

FIG. 1 is a schematic diagram of the structure of a touch panel in the relevant art;

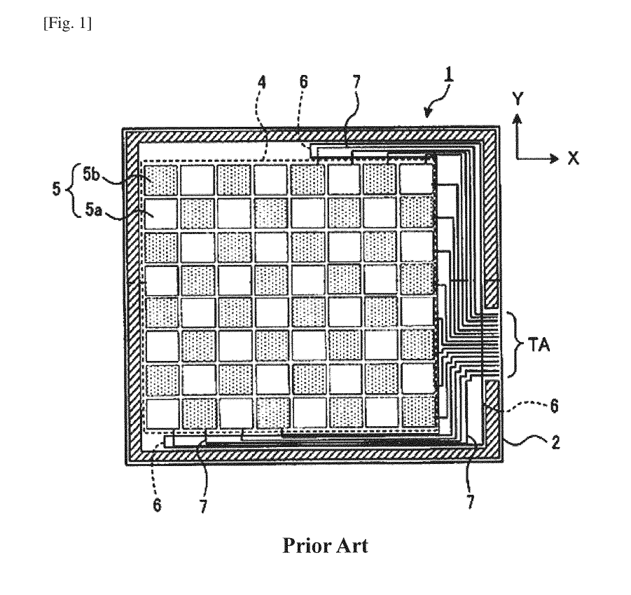

FIG. 2 is another schematic diagram of the structure of a touch panel in the relevant art;

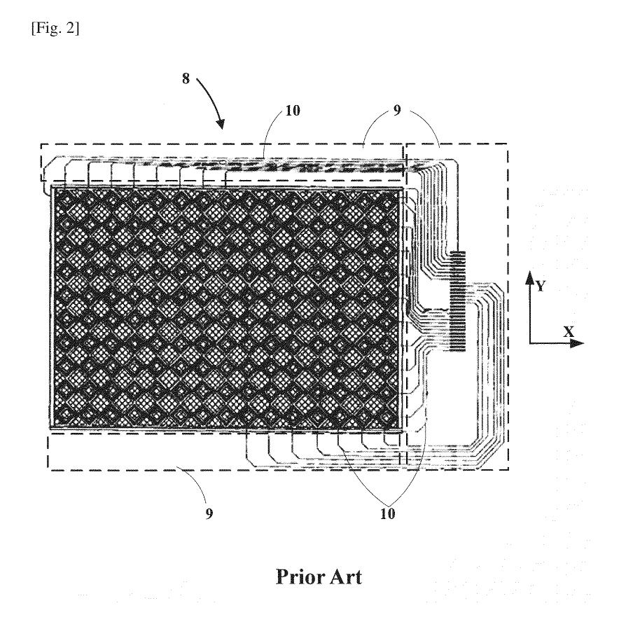

FIG. 3 is a schematic diagram of the structure of a touch panel in Embodiment 1 of the present disclosure;

FIG. 4 is a schematic diagram of the structure of a touch panel with driving lines and detecting lines being perpendicular to each other in Embodiment 1 of the present disclosure;

FIG. 5 (a)-FIG. 5 (c) are cross-sectional illustrations along the direction A-A in FIG. 3;

FIG. 6 is the schematic diagram of the structure of a touch panel with two detection regions located on different surfaces in Embodiment 1;

FIG. 7 is a schematic diagram of the structure of a display apparatus in Embodiment 2 of the present disclosure; and

FIG. 8 is a block diagram of a system construction of an electronic device in Embodiment 3 of the present disclosure.

### DESCRIPTION OF EMBODIMENTS

The above and other features of the present disclosure will be described with reference to the drawings. The descriptions and the drawings disclose embodiments of the present disclosure, which are some of the embodiments capable of employing principles of the present disclosure. To be noted, the present disclosure is not limited to the described embodiments. On the contrary, the present disclosure includes any amendment, modification and equivalence falling within the scope of the accompanying claims.

### Embodiment 1

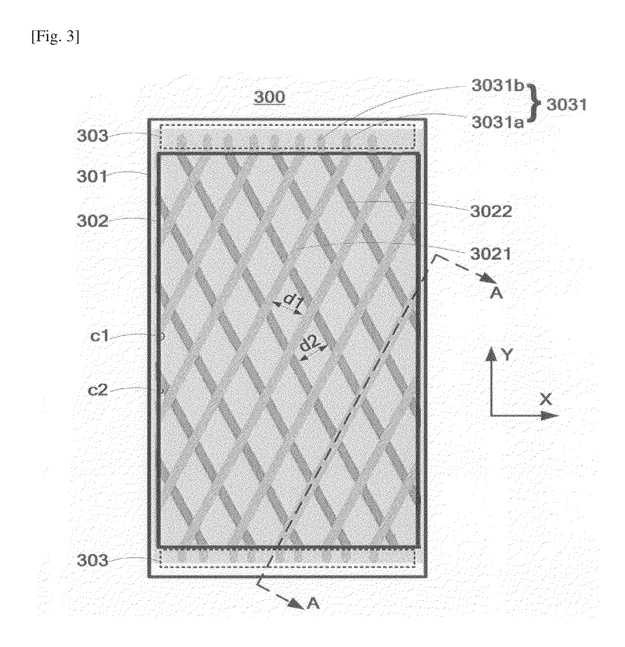

Embodiment 1 of the present disclosure provides a touch panel. FIG. 3 is a schematic diagram of the structure of a touch panel in Embodiment 1 of the present disclosure. As shown in FIG. 3, the touch panel 300 includes a substrate 301, which has a rectangular detection region 302 and electrode regions 303 at the peripheries of the detection region 302. As shown in FIG. 3, for the convenience of description, the directions in which two adjacent sides of the substrate 301 extend are referred to as directions X and Y, respectively.

In the embodiment of the present disclosure, the detection region 302 may be provided with a plurality of detection lines 3021 electrically separated from one another; the detection region 302 may be also provided with a plurality of driving lines 3022 electrically separated from one another; the detection lines 3021 and the driving lines 3022 may be configured crosswise, and the extending directions of the detection lines 3021 and/or the driving lines 3022 are not parallel with any side of the detection region 302; the electrode region 303 is provided with a plurality of electrodes 3031 electrically connected to the detection lines 3021 and the driving lines 3022, respectively.

In the embodiment of the present disclosure, a capacitor may be formed at the intersection of the detection line 3021 and the driving line 3022, so as to calculate the coordinates of the touch position by detecting the change of each capacitance. For the specific detection and calculation methods, please refer to the relevant art, and herein are omitted.

In the embodiment of the present disclosure, both the detection lines 3021 and the driving lines 3022 may be configured to be inclined relative to directions X and Y, or just the detection lines 3021 are configured to be inclined relative to directions X and Y while the driving lines 3022 are parallel with direction X or Y, or just the driving lines 3022 are configured to be inclined relative to directions X and Y while the detection lines 3021 are parallel with direction X or Y.

In the embodiment of the present disclosure, the detection lines 3021 and/or the driving lines 3022 are configured to be inclined relative to directions X and Y, thus as compared with the technical solution of the relevant art in which the detection lines and the driving lines are parallel with directions X and Y respectively, the number of electrodes above and below the detection region is increased, while the number of electrodes on the left and right of the detection region is decreased and even zero. Thus, the electrode regions outside the left and right sides of the detection region are reduced or eliminated, then the left and right border sizes of the touch panel are reduced, and a touch panel of compact structure can be formed.

Next, the embodiment of the present disclosure is further described with reference to FIG. 3-FIG. 6.

In Embodiment 1 of the present disclosure, the detection lines 3021 are parallel with each other, the driving lines 3022 are parallel with each other, and the distance between any two adjacent detection lines 3021 is equal to the distance between any two adjacent driving lines 3022. As shown in FIG. 3, the detection lines 3021 may be arranged as parallel with each other, having the distance between any two adjacent detection lines 3021 equal to a first distance d1, and the driving lines 3022 may be arranged as parallel with each other, having the distance between any two adjacent driving lines 3022 equal to a second distance d2. In a particular embodiment, the first distance d1 and the second distance d2 may be equal to each other, so that the intersections of the detection lines 3021 and the driving lines 3022 are uniformly distributed in the entire detection region 302.

In addition, the distance between the detection lines 3021 and the distance between the driving lines 3022 may be adjusted upon demand, e.g., as may be desired, so that the above intersections are not uniformly distributed in the detection region 302. For example, at a measurement touch position requiring a high accuracy, the first distance d1 and/or the second distance d2 may be decreased, and at a measurement touch position not requiring a high accuracy, the first distance d1 and/or the second distance d2 may be increased.

In Embodiment 1 of the present disclosure, both the detection line 3021 and the driving line 3022 are configured to be inclined relative to directions X and Y, and for one side of the detection region 301, the angle between the side and the detection line 3021 and the angle between the side and the driving line 3022 are supplementary to each other. As shown in FIG. 3, for example for the left side of the detection region 302, and the angle between the left side and the detection line 3021 is c1, the angle between the left side and the driving line 3022 in the same direction is c2, wherein c1 and c2 are supplementary to each other, i.e., c1+c2=180 degrees. Thus, the wiring patterns of the detection line and the driving line can achieve good symmetrical characteristics.

In addition, in the embodiment of the present disclosure, c1 and c2 may also be not supplementary to each other. For example, the detection lines 3021 (or the driving lines 3022) may be parallel with direction Y, and the driving lines 3022 (or the detection lines 3021) may be parallel with neither of directions X or Y, i.e., just the detection lines 3021 or the driving lines 3022 are configured to be inclined relative to directions X and Y. In that case, the number of electrodes above and below the detection region is increased, while the number of electrodes on the left and right of the detection region is decreased and even zero, thereby forming a touch panel of compact structure.

As shown in FIG. 3, in Embodiment 1 of the present disclosure, the detection lines and/or the driving lines may be inclined at a predetermined angle, so that each of the detection lines 3021 and each of the driving lines 3022 can intersect with at least one of the upper and lower sides of the detection region 302. Thus, the electrode region 303 may be only provided outside the upper and lower sides of the detection region 302, without being provided outside the left and right sides of the detection region 302. Thus, the border widths of the left and right sides of the touch panel may be further reduced to form a touch panel of more compact structure.

To be noted, in the embodiment, the electrode region 303 is provided outside the upper and lower sides of the detection region 302, but the embodiment of the present disclosure is not limited thereto. The electrode region may also be provided outside any two opposite sides of the detection region, e.g., the detection lines and/or driving lines may be inclined at a predetermined angle, so that each of the detection lines 3021 and each of the driving lines 3022 can intersect with at least one of the left and right sides of the detection region 302. Thus, the electrode region 303 may be only provided outside the left and right sides of the detection region 302.

As shown in FIG. 3, in the embodiment of the present disclosure, for any of the upper and lower sides of the detection region 302, since both the detection lines 3021 and the driving lines 3022 intersect with the side, the electrode region 303 outside the side includes electrodes 3031a connected to the detection lines 3021 and electrodes 3031b electrically connected to the driving lines 3022. In addition, in the embodiment of the present disclosure, the electrodes 3031a and 3031b may be alternatively (as for the meaning of “alternatively”: please refer to FIG. 3, in electrode region 303, the electrodes are arranged along X direction in the form of 3031b, 3031a, 3031b, 3031a, 3031b, 3031a, 3031b, 3031a . . . ) arranged in direction X, but the present disclosure is not limited thereto. For example, the electrodes 3031a and 3031b also may not be alternatively arranged in a case where the intersections are not uniformly distributed, or the number of the detection lines is unequal to the number of the driving lines.

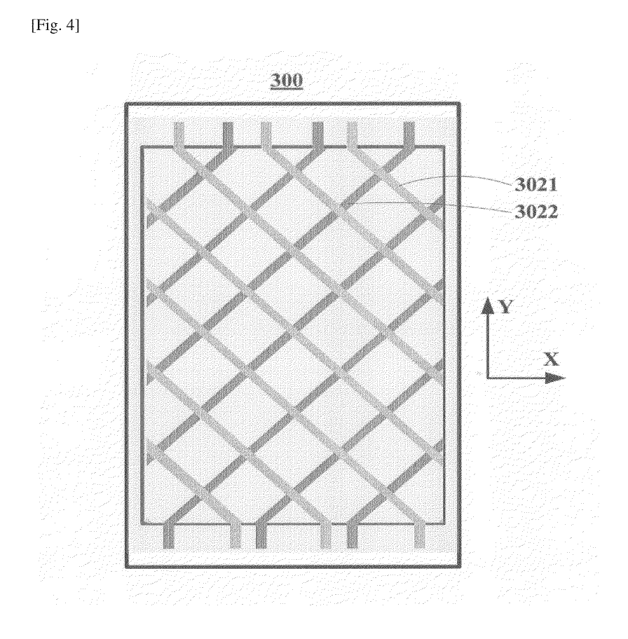

In addition, in FIG. 3, the detection line 3021 and the driving line 3022 are not perpendicular to each other, but the present disclosure is not limited thereto. In another embodiment, for example as shown in FIG. 4, the detection line 3021 and the driving line 3022 also may be perpendicular to each other.

In the embodiment of the present disclosure, the detection line 3021 and the driving line 3022 may be made of transparent conductive material, such as Indium Tin Oxide (ITO). Thus, the existence of the detection lines and the driving lines will not influence the light transmittance of the touch panel.

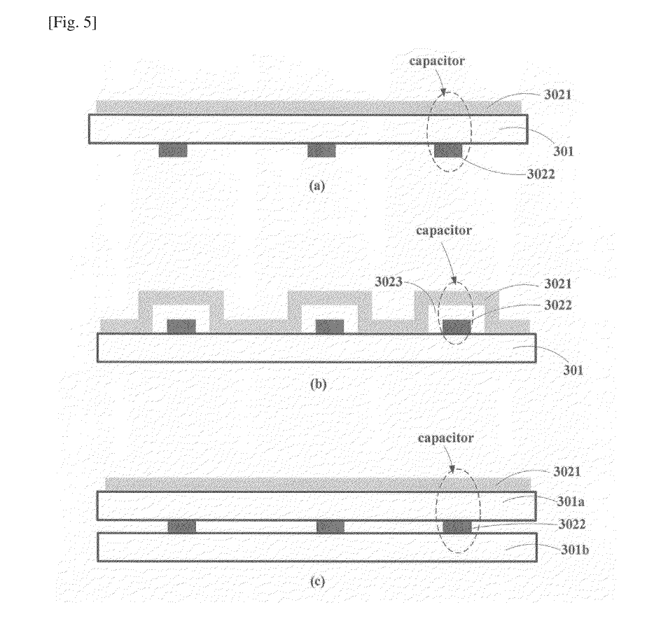

In the embodiment of the present disclosure, the detection lines 3021 and the driving lines 3022 may be electrically insulated at the intersections to form capacitors, and then the touch positions can be detected by detecting the changes of the capacitances. FIG. 5(a)-FIG. 5 (b) are cross-sectional illustrations along the direction A-A in FIG. 3. The capacitor may be formed in various manners as shown in FIG. 5 (a)-FIG. 5 (b). For example, as shown in FIG. 5 (a), the detection lines 3021 and the driving lines 3022 may be formed on the upper and lower surfaces of the substrate 301, respectively, wherein the substrate 301 is taken as the dielectric medium of the capacitors. Alternatively, as shown in FIG. 5 (b), the detection lines 3021 and the driving lines 3022 may be formed on the same surface of the substrate 301, and dielectric layers 3023 may be formed between the detection lines and the driving lines at the intersections. Further, alternatively, as shown in FIG. 5 (c), the substrate 301 may be provided as a structure having at least two layers 301a and 301b, wherein the detection lines 3021 and the driving lines 3022 may be located on different layers of the substrate.

In addition, in the embodiment of the present disclosure, both the detection lines and the driving lines are strip patterns, but the present disclosure is not limited thereto. Each of the detection lines and each of the driving lines may be a column of rectangular or diamond patterns electrically connected to each other, or patterns of other shapes.

In the embodiment of the present disclosure, the touch panel has a detection region parallel with the X-Y plane for detecting a touch, but the present disclosure is not limited thereto. The touch panels may be combined to form an extended touch panel, which has more than two detection regions located on different surfaces, thus the touches on multiple planes can be detected. For example, the extended touch panel may have detection regions corresponding to respective surfaces of a hexahedron.

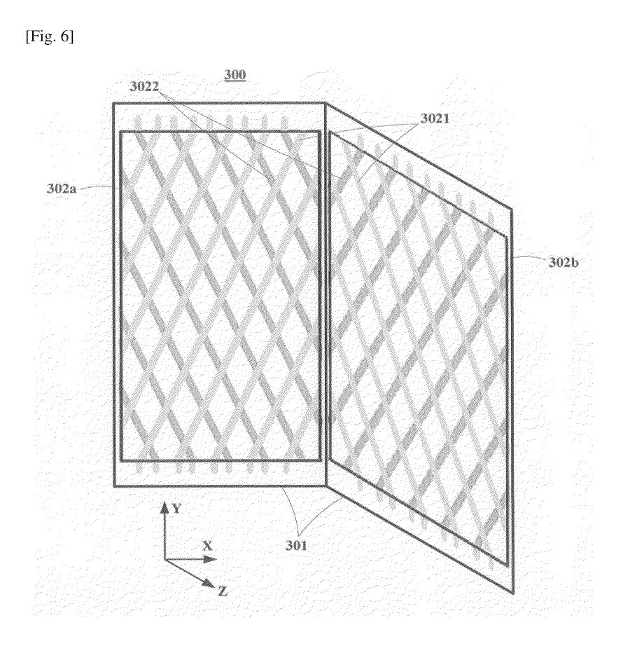

FIG. 6 is the schematic diagram of the structure of a touch panel with two detection regions located on different surfaces in Embodiment 1. As shown in FIG. 6, the touch panel 300 has two detection regions 302a and 302b. Detection region 302a is located on the surface X-Y, detection region 302a is located on the surface Z-Y, and the directions of Z may be perpendicular with directions X and Y.

In the embodiment of the present disclosure, each of the touch panels in the extended touch panel may adopt the structure of the touch panel as described in the embodiment of the present disclosure, thereby forming an extended touch panel of compact structure. In addition, for each of the touch panels, the electrode regions may be just located outside the two opposite sides of the detection region, and other sides different from the two opposite sides may be those of the touch panel adjacent to other touch panel, thus an electrode region may be not formed at the place where adjacent touch panels are connected to each other. As a result, the distance between the detection regions of adjacent touch panels can be reduced and even eliminated, thereby realizing a seamless connection between the detection regions, thus the touches on different surfaces can be detected continuously.

In the embodiment of the present disclosure, since the detection lines 3021 and/or the driving lines 3022 are configured to be inclined relative to directions X and Y, the number of electrodes above and below the detection region is increased, while the number of electrodes on the left and right of the detection region is decreased. Thus, the areas of the electrode regions outside the left and right sides of the detection region are reduced, and a touch panel of compact structure is formed. In addition, the electrode region 303 may be only provided outside the upper and lower sides of the detection region 302, without being provided outside the left and right sides of the detection region 302. Thus, the border widths of the left and right sides of the touch panel may be further reduced to form a touch panel of more compact structure. In addition, by setting the distance between the detection lines 3021 and the distance between the driving lines 3022 to be equal to each other, the intersections are uniformly distributed in the entire detection region 302. In addition, for one side of the detection region 301, the angle between the side and the detection line 3021 and the angle between the side and the driving line 3022 may be supplementary to each other. Thus, the wiring patterns of the detection line and the driving line achieve good symmetrical characteristics. In addition, the touch panels may be combined to form an extended touch panel of compact structure. Moreover, the touches on different surfaces can be detected continuously.

### Embodiment 2

Embodiment 2 of the present disclosure provides a display apparatus, including an electrical connection device and a touch panel 300 according to Embodiment 1, wherein the detection lines and the driving lines of the touch panel are electrically connected, through an electrode, to the electrical connection device which transmits detection signals on the detection lines and the driving lines to a processing device to calculate touch positions.

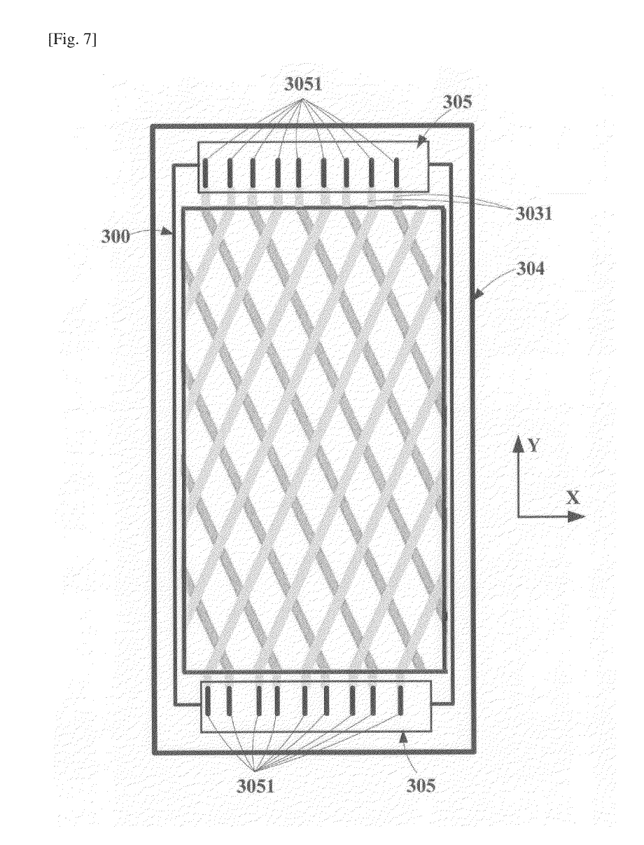

FIG. 7 is a schematic diagram of the structure of a display apparatus in Embodiment 2 of the present disclosure. As shown in FIG. 7, the display apparatus 304 includes the touch panel 300 and the electrical connection device 305. The electrical connection device 305 includes conducting lines 3051, which electrically connects to electrodes 3031 of the touch panel 300.

In the embodiment of the present disclosure, the electrical connection device 305 for example may be a flexible printed circuit board.

In the embodiment of the present disclosure, the display apparatus may be a liquid crystal display apparatus having a liquid crystal display panel, wherein the touch panel may be located above or below the liquid crystal display panel, or located in the liquid crystal display panel.

According to the embodiment, the areas of the electrode regions can be reduced to form a touch panel of compact structure, thereby forming a display apparatus of compact structure.

### Embodiment 3

Embodiment 3 of the present disclosure provides an electronic device including a display apparatus 304 according to Embodiment 2.

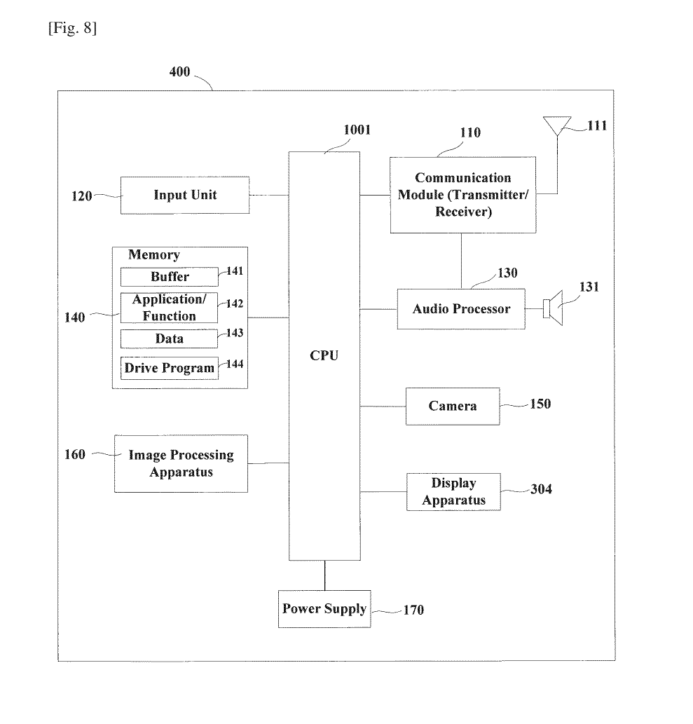

FIG. 8 is a block diagram of a system construction of an electronic device 400 in the embodiment of the present disclosure, including the display apparatus 304 according to Embodiment 2 of the present disclosure. To be noted, the drawing is an example, and other type of structure may be used to supplement or replace the structure to realize the telecom function or other function.

As shown in FIG. 8, the electronic device 400 may include a Central Processing Unit (CPU) 1001, a communication module 110, an input unit 120, an audio processor 130, a memory 140, a camera 150, an image processing apparatus 160, a power supply 170 and a display apparatus 304, wherein the display apparatus 304 is configured to display an image, detect a user's touch on the touch panel, and acquire a detection result. The structure of the display apparatus 304 is the same as that of the display apparatus in Embodiment 2, and herein is omitted.

The CPU 1001 (sometimes referred to as controller or operation control, including a microprocessor or other processor unit and/or logic unit) receives an input and controls respective parts and the operation of the electronic device 400.

In the embodiment, the CPU 1001 may calculate the user's touch position on the touch panel according to the detection result of the display apparatus 304, and give corresponding control instruction according to the touch position.

The input unit 120 provides an input to the CPU 1001. The input unit 120 for example is a key input means. The camera 150 acquires image data and provides the acquired image data to the CPU 1001 for a conventional usage, such as storage, transmission, etc.

The power supply 170 supplies electric power to the electronic device 400. The image processing apparatus 160 processes an object such as image, video or text.

The memory 140 is coupled to the CPU 1001. The memory 140 may be a solid-state memory such as Read Only Memory (ROM), Random Access Memory (RAM), Subscriber Identity Module (SIM) card, etc. It may also be such a memory which stores information even if the power is off, and which can be selectively erased and provided with more data. The example of the memory sometimes is referred to as EPROM. The memory 140 may also be other type of device. The memory 140 includes a buffer memory 141 (sometimes referred to as buffer). The memory 140 may include an application/function storage section 142 configured to store application programs and function programs, or to perform procedures of the operation of the electronic device 400 through the CPU 1001.

The memory 140 may further include a data storage section 143 configured to store data. A drive program storage section 144 of the memory 140 may include various drive programs of the electronic device for performing the communication function and/or other functions (e.g., message transfer application, address book application, etc.) of the electronic device.

The communication module 110 is a transmitter/receiver 110 which transmits and receives signals via an antenna 111. The communication module (transmitter/receiver) 110 is coupled to the CPU 1001, so as to provide an input signal and receive an output signal, which may be the same as the situation of conventional mobile communication terminal.

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 via an audio processor 130, so as to provide an audio output via the speaker 131. The audio processor 130 may include any suitable buffer, decoder, amplifier, etc.

The present disclosure is described as above through the particular embodiments. But a person skilled in the art shall appreciate that those descriptions are just exemplary rather than limitations to the protection scope of the present disclosure. A person skilled in the art can make various modifications and amendments to the present disclosure according to the spirit and the principle of the present disclosure, and those modifications and amendments also fall within the protection scope of the present disclosure.

Particular embodiments of the present disclosure have been disclosed herein. A person skilled in the art will readily recognize that the present disclosure is applicable in other environments. In practice, there exist many embodiments and implementations. The accompanied claims are by no means intended to limit the scope of the present disclosure to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present disclosure has been described, it is obvious that equivalent amendments and modifications are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. A touch panel, comprising:
a substrate having a rectangular detection region and electrode regions located at the peripheries of the detection region;
a plurality of detection lines formed in the detection region and electrically separated from one another;
a plurality of driving lines formed in the detection region and electrically separated from one another; and
a plurality of electrodes located in the electrode regions and electrically connected to the detection lines and the driving lines, respectively;
wherein, the detection lines and the driving lines are configured crosswise, and the extending directions of the detection lines and/or the driving lines are not parallel with any side of the detection region.

2. The touch panel according to claim 1, wherein the electrode regions are located outside two opposite sides of the detection region.

3. The touch panel according to claim 1, wherein the detection line and the driving line are perpendicular or not perpendicular to each other.

4. The touch panel according to claim 1, wherein the detection lines are parallel with one another, the driving lines are parallel with one another, and a distance between any adjacent two of the detection lines is equal to a distance between any adjacent two of the driving lines.

5. The touch panel according to claim 1, wherein an angle between one side of the detection region and the detection line and an angle between the side and the driving line are supplementary to each other.

6. The touch panel according to claim 1, wherein electrodes connected to the detection lines and electrodes connected to the driving lines are arranged alternatively.

7. The touch panel according to claim 1, wherein the detection lines and the driving lines are made of transparent conductive material.

8. The touch panel according to claim 1, wherein the detection lines and the driving lines are electrically insulated from each other at an intersection.

9. The touch panel according to claim 1, wherein the detection lines and the driving lines are located on upper and lower surfaces of the substrate, respectively.

10. The touch panel according to claim 1, wherein the detection lines and the driving lines are located on the same surface of the substrate.

11. The touch panel according to claim 1, wherein the substrate has two layers, and the detection lines and the driving line are provided on different layers of the substrate, respectively.

12. The touch panel according to claim 1, wherein the touch panel has more than two detection regions which are located on different planes.

13. A display apparatus, comprising a touch panel according to claim 1, and an electrical connection device, wherein the detection lines and the driving lines of the touch panel are electrically connected to the electrical connection device through the electrodes.

14. The display apparatus according to claim 13, wherein the electrical connection device is a flexible printed circuit board.

15. An electronic device, comprising a display apparatus according to claim 1.

16. (canceled)

17. An extended touch panel comprising a plurality of touch panels as set forth in claim 1, and wherein the plurality of touch panels are coupled together to provide separate detection regions which are located on different planes.

18. An extended touch panel as set forth in claim 17, wherein two touch panels are adjacent each other, and the electrode regions of the respective adjacent touch panels are located outside two opposite sides of the detection region, and wherein another side of one of the respective touch panels is adjacent another side of the other of the respective touch panels.

19. An extended touch panel as set forth in claim 18, wherein the respective touch panels that are coupled together are coupled at a substantially seamless connection between the respective detection regions of the touch panels.
